(19) United States
(12) Patent Application Publication
(10) Pub. No.: US 2020/0343603 A1
(43) Pub. Date: Oct. 29, 2020

(54) COOLING DEVICE

(71) Applicants: TOYOTA JIDOSHA KABUSHIKI KAISHA, Aichi-ken (JP); DENSO CORPORATION, Aichi-pref (JP)

(72) Inventors: Satoko TOFUKUJI, Tokyo-to (JP); Yusuke SUZUKI, Nagakute-shi (JP); Takeshi YOSHINORI, Kariya-city (JP); Yasumitsu OOMI, Kariya-city (JP); Kouji MIURA, Kariya-city (JP)

(21) Appl. No.: 16/857,100

(22) Filed: Apr. 23, 2020

(30) Foreign Application Priority Data
Apr. 26, 2019 (JP) 2019-086777

(51) Int. Cl. H01M 10/613; B60K 11/02; F28D 15/02; H01M 10/625; H01M 10/6556; H01M 10/6569

(52) U.S. Cl. CPC H01M 10/613; B60K 11/02; F28D 15/02; B60H 1/32; H01M 10/6556; H01M 10/6569; H01M 10/625

(57) ABSTRACT

A cooling device includes: an evaporator configured to cool a battery pack by evaporating a heat medium by heat exchange between the battery pack and the heat medium, the battery pack including a plurality of battery cells arranged in an arrangement direction; a condenser disposed above the evaporator and configured to radiate heat of the heat medium to an external fluid by condensing the heat medium by heat exchange between the heat medium and the external fluid; a gas-phase passage configured to guide the heat medium in a gas phase from the evaporator to the condenser; and a liquid-phase passage configured to guide the heat medium in a liquid phase from the condenser to the evaporator, wherein a cooling amount at an end of the evaporator in the arrangement direction is lower than a cooling amount at a center of the evaporator in the arrangement direction.

The present application claims priority to and incorporates by reference the entire contents of Japanese Patent Application No. 2019-086777 filed in Japan on Apr. 26, 2019.

### BACKGROUND

The present disclosure relates to a cooling device.

WO 2018/070115 A discloses a device temperature controller as a cooling device that cools a battery pack including a plurality of battery cells arranged by a boiling and condensing action of a working fluid as a heat medium. This device temperature controller includes a condenser and an evaporator. The condenser is disposed at a position higher than the evaporator, and a liquid-phase working fluid is retained in a lower part of the evaporator. Then, the condenser and the evaporator are connected in a ring shape by a liquid passage that is a liquid phase passage formed of a pipe member and a gas passage that is a gas phase passage, and the device temperature controller is configured such that a working fluid circulates between the condenser and the evaporator. Further, the evaporator is disposed so as to be in contact with a side surface of the battery pack configured by arranging a plurality of battery cells, and cools the battery pack by evaporating the working fluid. Further, the evaporator is formed to extend in the arrangement direction of the plurality of battery cells. The liquid-phase working fluid from the condenser flows into the evaporator from one end of the evaporator in the battery cell arrangement direction through the liquid passage. Then, the liquid-phase working fluid in the evaporator evaporates while flowing from one end to the other end in the battery cell arrangement direction, and gas-phase working fluid flows out from the other end into the gas passage and passes through the gas passage and moves to the condenser.

### SUMMARY

In the device temperature controller disclosed in WO 2018/070115 A, there is a possibility that a large temperature difference occurs between the end and the center of a battery pack in a battery cell arrangement direction. As a factor of this, for example, in an evaporator, since a working fluid flows from one end to the other end in the battery cell arrangement direction, there is a possibility that the end on one end side in the battery cell arrangement direction is more likely to be cooled than the center. Further, the battery cells located at both ends in the battery cell arrangement direction are in contact with a cold object such as an end plate, and may be more easily cooled than the battery cells located at the center in the battery cell arrangement direction. Furthermore, the battery cells located at both ends in the battery cell arrangement direction may be more likely cooled than the battery cells located at the center in the battery cell arrangement direction because one surface is not in contact with a heating element such as another battery cell. Due to these factors, there is a possibility that the temperature of the ends in the battery cell arrangement direction of the battery pack is lower than that of the center.

There is a need for a cooling device that reduces a temperature difference between the ends and the center of a battery pack in a battery cell arrangement direction.

According to one aspect of the present disclosure, there is provided a cooling device including: an evaporator configured to cool a battery pack by evaporating a heat medium by heat exchange between the battery pack and the heat medium, the battery pack including a plurality of battery cells arranged in an arrangement direction; a condenser disposed above the evaporator and configured to radiate heat of the heat medium to an external fluid by condensing the heat medium by heat exchange between the heat medium and the external fluid; a gas-phase passage configured to guide the heat medium in a gas phase from the evaporator to the condenser; and a liquid-phase passage configured to guide the heat medium in a liquid phase from the condenser to the evaporator, wherein a cooling amount at an end of the evaporator in the arrangement direction is lower than a cooling amount at a center of the evaporator in the arrangement direction.

### BRIEF DESCRIPTION OF THE DRAWINGS

FIG. 1 is a schematic diagram illustrating a schematic configuration of a cooling device according to a first embodiment;

FIG. 2 is a cross-sectional view of an evaporator provided in the cooling device according to the first embodiment;

FIG. 3 is a cross-sectional view of an evaporator provided in a cooling device according to a second embodiment;

FIG. 4 is a cross-sectional view of an evaporator provided in a cooling device according to a third embodiment;

FIG. 5 is a cross-sectional view of an evaporator provided in a cooling device according to a fourth embodiment;

FIG. 6A is a cross-sectional view taken along line A-A of FIG. 5;

FIG. 6B is a cross-sectional view taken along line B-B of FIG. 5;

FIG. 6C is a diagram illustrating another example of a cross-section taken along line AA of FIG. 5;

FIG. 7 is a cross-sectional view of an evaporator provided in a cooling device according to a fifth embodiment;

FIG. 8 is a diagram of a battery pack and an evaporator provided in a cooling device according to a sixth embodiment as viewed from the battery pack side in a direction orthogonal to a battery cell arrangement direction;

FIG. 9A is a cross-sectional view taken along line C-C of FIG. 8;

FIG. 9B is a cross-sectional view taken along line D-D of FIG. 8;

FIG. 10A is a diagram illustrating another example of a cross section taken along line CC of FIG. 8;

FIG. 10B is a diagram illustrating another example of a cross section taken along line DD of FIG. 8;

FIG. 11A is a diagram illustrating another example of a cross section taken along line CC of FIG. 8;

FIG. 11B is a diagram illustrating another example of a cross section taken along line DD of FIG. 8;

FIG. 12A is a diagram illustrating another example of a cross section taken along line CC of FIG. 8;

FIG. 12B is a diagram illustrating another example of a cross section taken along line DD of FIG. 8;

FIG. 13 is a diagram of a battery pack and an evaporator provided in a cooling device according to a seventh embodiment as viewed from the battery pack side in a direction orthogonal to a battery cell arrangement direction;

FIG. 14A is a cross-sectional view taken along line E-E of FIG. 13;

FIG. 14B is a cross-sectional view taken along line F-F of FIG. 13; and

FIG. 15 is an exploded view of an evaporator integrally formed by pressing and joining a pair of metal plates.

### DETAILED DESCRIPTION

### First Embodiment

Hereinafter, a cooling device according to a first embodiment will be described. Note that the present disclosure is not limited by the embodiment.

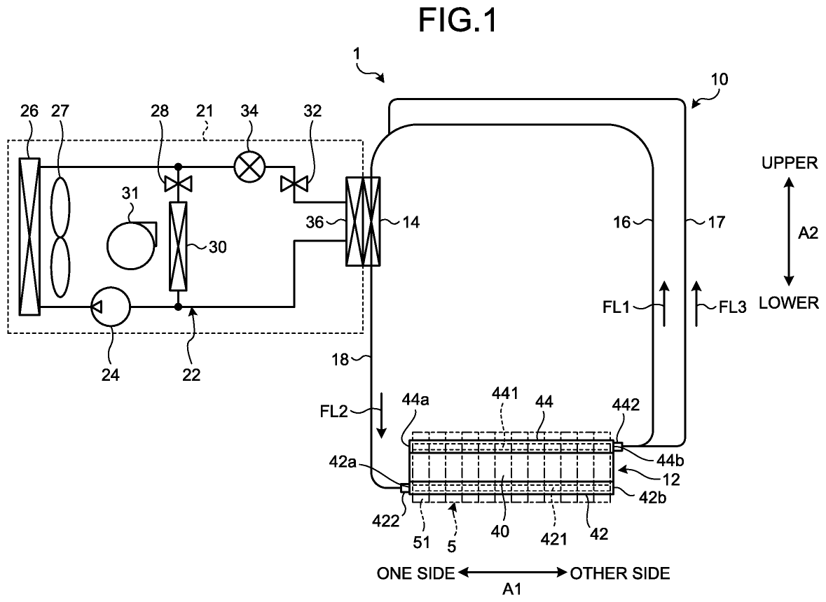

FIG. 1 is a schematic diagram illustrating a schematic configuration of the cooling device 1 according to the first embodiment. The cooling device 1 according to the first embodiment illustrated in FIG. 1 adjusts the battery temperature of a battery pack 5 mounted on a vehicle by cooling the battery pack 5 as an object to be cooled. As the vehicle on which the cooling device 1 is mounted, an electric vehicle or a hybrid vehicle that may be driven by a driving electric motor (not illustrated) using the battery pack 5 as a power source is assumed.

The battery pack 5 has a plurality of battery cells 51 having a rectangular parallelepiped shape. A plurality of the battery cells 51 are arranged in a battery cell arrangement direction A1, which is a predetermined arrangement direction. Therefore, the entire battery pack 5 also has a substantially rectangular parallelepiped shape. In the present embodiment, the battery cell arrangement direction A1 is a direction intersecting a vehicle vertical direction A2, more specifically, a direction orthogonal to the vehicle vertical direction A2.

The cooling device 1 includes a working fluid circuit 10 in which a working fluid circulates. As the working fluid that circulates through the working fluid circuit 10, a refrigerant (for example, R134a and R1234yf) used in a vapor compression refrigeration cycle is employed. As illustrated in FIG. 1, the working fluid circuit 10 includes an evaporator 12, a condenser 14, a first gas passage 16, a second gas passage 17, and a liquid passage 18. That is, the working fluid circuit 10 is a closed annular fluid circuit. A predetermined amount of working fluid is sealed in the working fluid circuit 10, and the inside of the working fluid circuit 10 is filled with the working fluid.

The evaporator 12 is a heat exchanger that exchanges heat between the working fluid flowing in the evaporator 12 and the battery pack 5. That is, as the working fluid circulates in the working fluid circuit 10, the evaporator 12 absorbs heat from the battery pack 5 to the liquid-phase working fluid to evaporate (boil and vaporize) the liquid-phase working fluid. The evaporator 12 of the present embodiment is connected to the side of the battery pack 5 so as to be able to conduct heat. Further, the evaporator 12 is disposed below the condenser 14. Thus, the liquid-phase working fluid is accumulated in the lower part of the working fluid circuit 10 including the evaporator 12 by gravity.

The condenser 14 is a heat exchanger that condenses the gas-phase working fluid evaporated by the evaporator 12. The condenser 14 condenses the working fluid by radiating heat from the gas-phase working fluid by heat exchange with a refrigerant that is an external fluid of an air conditioning refrigeration cycle device 21 mounted on a vehicle. The refrigeration cycle device 21 forms a part of a vehicle air conditioner. The refrigeration cycle device 21 includes a refrigerant circuit 22 through which refrigerant circulates and flows.

The condenser 14 is thermally connected to a refrigerant-side heat exchanger 36 through which the refrigerant of the refrigerant circuit 22 flows, such that heat may be exchanged between the refrigerant-side heat exchanger 36 and the working fluid flowing through the condenser 14.

The refrigerant circuit 22 forms a vapor compression refrigeration cycle. Specifically, the refrigerant circuit 22 is formed by connecting a compressor 24, an air conditioning condenser 26, a first expansion valve 28, an air conditioning evaporator 30, and the like by piping. The refrigeration cycle device 21 includes a blower 27 that sends air to the air conditioning condenser 26, and a blower 31 that forms an airflow toward the vehicle interior space. For example, the air conditioning condenser 26 and the blower 27 are provided outside the vehicle compartment, and the blower 27 sends outside air, which is air outside the vehicle compartment, to the air conditioning condenser 26.

The compressor 24 compresses and discharges refrigerant. The air conditioning condenser 26 is a radiator that radiates and condenses the refrigerant flowing out of the compressor 24 by heat exchange with air. The first expansion valve 28 reduces the pressure of the refrigerant flowing out of the air conditioning condenser 26. The air conditioning evaporator 30 evaporates the refrigerant flowing out of the first expansion valve 28 by heat exchange with the air flowing toward the vehicle interior space, and cools the air flowing toward the vehicle interior space.

Further, the refrigerant circuit 22 has a second expansion valve 32 and a refrigerant-side heat exchanger 36 connected in parallel with the first expansion valve 28 and the air conditioning evaporator 30 in a refrigerant flow. The second expansion valve 32 decompresses the refrigerant flowing out of the air conditioning condenser 26. The refrigerant-side heat exchanger 36 is a refrigerant evaporator that evaporates the refrigerant by heat exchange with the working fluid flowing through the condenser 14.

Further, the refrigerant circuit 22 has an on-off valve 34 for opening and closing a refrigerant channel through which the refrigerant flows toward the refrigerant-side heat exchanger 36. By closing the on-off valve 34, a first refrigerant circuit through which the refrigerant flows in the order of the compressor 24, the air conditioning condenser 26, the first expansion valve 28, and the air conditioning evaporator 30 is formed. By opening the on-off valve 34, in addition to the first refrigerant circuit, a second refrigerant circuit in which the refrigerant flows in the order of the compressor 24, the air conditioning condenser 26, the second expansion valve 32, and the refrigerant-side heat exchanger 36 is formed.

The on-off valve 34 is opened and closed appropriately according to predetermined conditions according to the necessity of cooling the battery pack 5, for example. When the on-off valve 34 is opened, at least the compressor 24 and the blower 27 operate. As a result, in the condenser 14, the gas-phase working fluid is cooled and condensed by heat exchange with the refrigerant flowing through the refrigerant-side heat exchanger 36.

Subsequently, a basic operation of the cooling device 1 according to the first embodiment will be described with reference to FIG. 1.

In the cooling device 1, when the battery temperature of the battery pack 5 rises due to self-heating during traveling of a vehicle or the like, the heat of the battery pack 5 moves to the evaporator 12. In the evaporator 12, a part of the liquid-phase working fluid evaporates by absorbing heat from the battery pack 5. The battery pack 5 is cooled by latent heat of evaporation of the working fluid present inside the evaporator 12, and the temperature of the battery pack 5 decreases.

The working fluid evaporated in the evaporator 12 flows out of the evaporator 12 to the first gas passage 16 and moves to the condenser 14 through the first gas passage 16 as indicated by an arrow FL1 in FIG. 1.

In the condenser 14, the liquid-phase working fluid condensed by radiating the heat of the gas-phase working fluid descends by gravity. Thereby, the liquid-phase working fluid condensed in the condenser 14 flows out of the condenser 14 to the liquid passage 18 and moves to the evaporator 12 through the liquid passage 18 as indicated by an arrow FL2 in FIG. 1. Then, in the evaporator 12, a part of the inflowing liquid-phase working fluid is evaporated by absorbing heat from the battery pack 5.

Thus, in the cooling device 1, the working fluid circulates between the evaporator 12 and the condenser 14 while changing its phase between the gas state and the liquid state, and heat is transported from the evaporator 12 to the condenser 14. Thus, the battery pack 5 to be cooled is cooled. The cooling device 1 is configured such that the working fluid naturally circulates inside the working fluid circuit 10 even if there is no driving force for circulation of the working fluid by a compressor or the like. For this reason, the cooling device 1 may realize efficient cooling of the battery pack 5 while suppressing both power consumption and noise.

Next, the structure of the evaporator 12 will be described. As illustrated in FIG. 1, the evaporator 12 includes a fluid evaporation unit 40, a liquid supply unit 42 connected to a lower end of the fluid evaporation unit 40, and a fluid outflow unit 44 connected to an upper end of the fluid evaporation unit 40. The fluid outflow unit 44 is disposed above the liquid supply unit 42 and the fluid evaporation unit 40, and the liquid supply unit 42 is disposed below the fluid outflow unit 44 and the fluid evaporation unit 40.

The fluid evaporation unit 40 is connected to the battery pack 5 so as to be able to conduct heat by contacting a heat conductive material (not illustrated) interposed between the fluid evaporation unit 40 and the battery pack 5. For example, in order to increase the thermal conductivity between the fluid evaporation unit 40 and the battery pack 5, the fluid evaporation unit 40 is held in a state pressed against the battery pack 5.

The heat conductive material has electrical insulation and high thermal conductivity, and is sandwiched between the fluid evaporation unit 40 and the battery pack 5 in order to increase the thermal conductivity between the fluid evaporation unit 40 and the battery pack 5. As the heat conductive material, for example, a semisolid sheet is used. If the electrical insulation and the thermal conductivity between the fluid evaporation unit 40 and the battery pack 5 are sufficiently ensured, the fluid evaporation unit 40 may be in direct contact with the battery pack 5 without providing the heat conductive material.

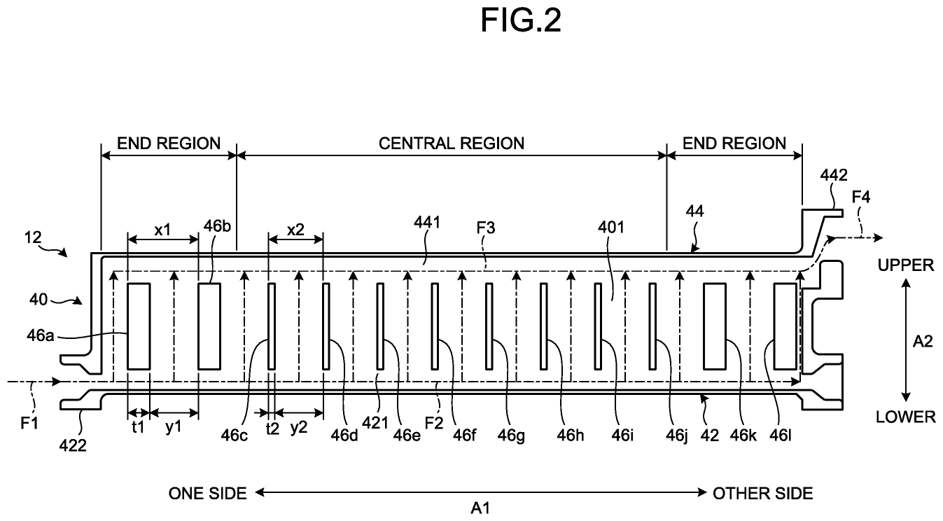

As illustrated in FIG. 2, a plurality of evaporation channels 401 extending in the vehicle vertical direction A2 are formed in the fluid evaporation unit 40 in parallel in the battery cell arrangement direction A1. Then, the fluid evaporation unit 40 evaporates the working fluid flowing through the plurality of evaporation channels 401 with the heat of the battery pack 5. That is, the liquid-phase working fluid flowing into each of the evaporation channels 401 is vaporized in each of the evaporation channels 401 while flowing through each of the evaporation channels 401.

The evaporator 12 performs a cutting process on a pair of metal plates to form a flow path through which a working fluid flows, such as a plurality of the evaporation channels 401 to be integrally formed by joining. That is, the evaporator 12 is integrally formed by joining a peripheral edge portion and a plurality of partitions 46a to 46l separating adjacent evaporation channels 401 in a pair of cut metal plates. A pair of the metal plates is made of a metal such as an aluminum alloy having high thermal conductivity. Further, the joining of a pair of the metal plates is performed by, for example, brazing. In addition, as a joining method of a pair of the metal plates, laser welding etc. may be used.

Each of the cross sections of a plurality of the evaporation channels 401 has a flat cross section extending in the battery cell arrangement direction A1. In other words, in a cross section orthogonal to the extending direction of the evaporation channel 401 (that is, in the present embodiment, the vehicle vertical direction A2), the cross-sectional shape of the evaporation channel 401 has a flat shape with the battery cell arrangement direction A1 as a longitudinal direction.

In the evaporation channel 401, the working fluid flows from below to above in the vehicle vertical direction A2, in other words, from the upstream end to the downstream end in the working fluid flow direction, as indicated by a dashed-dotted arrow and a dashed arrow in FIG. 2.

The upstream ends of a plurality of the evaporation channels 401 are each connected to a supply channel 421. Therefore, the liquid supply unit 42 distributes and supplies the liquid-phase working fluid flowing into the supply channel 421 to each of the evaporation channels 401. On the other hand, the downstream ends of the evaporation channels 401 are connected to an outflow channel 441, respectively. Therefore, the working fluid flows into the outflow channel 441 from each of a plurality of the evaporation channels 401. Then, the fluid outflow unit 44 causes the working fluid flowing into the outflow channel 441 to flow out to the first gas passage 16 and the second gas passage 17.

As illustrated in FIG. 1, since the liquid supply unit 42 is formed to extend in the battery cell arrangement direction A1, it has one end 42a on one side in the battery cell arrangement direction A1 and has the other end 42b on the other side in the battery cell arrangement direction A1. At one end 42a of the liquid supply unit 42, a fluid inlet 422 to which the liquid passage 18 is connected is provided. The fluid inlet 422 communicates with the supply channel 421. On the other hand, the other end 42b of the liquid supply unit 42 forms the other end of the supply channel 421 in the battery cell arrangement direction A1, and closes the other end.

Since the fluid outflow unit 44 is formed to extend in the battery cell arrangement direction A1, it has one end 44a on one side in the battery cell arrangement direction A1 and has the other end 44b on the other side in the battery cell arrangement direction A1. At the other end 44b of the fluid outflow unit 44, a fluid outlet 442 to which the first gas passage 16 and the second gas passage 17 are connected is provided. The fluid outlet 442 communicates with the outflow channel 441. On the other hand, one end 44a of the fluid outflow unit 44 forms one end of the outflow channel 441 in the battery cell arrangement direction A1, and closes one end thereof. The fluid outflow unit 44 performs gas-liquid separation of a bubble flow in which the evaporated working fluid gas is blown up together with the liquid-phase working fluid, and the outflow channel 441 is a channel for discharging the separated working fluid gas.

Although the fluid evaporation unit 40 is in contact with a heat conductive material, the liquid supply unit 42 is disposed away from both the battery pack 5 and the heat conductive material. That is, the air interposed between the liquid supply unit 42, the battery pack 5, and the heat conductive material functions as a heat insulating unit that prevents heat transfer therebetween. The liquid supply unit 42 is not thermally connected to the battery pack 5 because the liquid supply unit 42 is disposed with the heat insulating unit interposed between the liquid supply unit 42 and the battery pack 5 and the heat conductive material. Further, since the fluid outflow unit 44 is also disposed away from both the battery pack 5 and the heat conductive material, it is not thermally connected to the battery pack 5.

As described above, since the evaporation channel 401, the supply channel 421, and the outflow channel 441 of the evaporator 12 communicate with each other, the working fluid flows through the evaporator 12 as indicated by a dashed line arrow in FIG. 2.

Specifically, the liquid-phase working fluid from the liquid passage 18 flows into the supply channel 421 from the liquid passage 18 via the fluid inlet 422 as indicated by an arrow F1 in FIG. 2. The inflowing liquid-phase working fluid flows from one side in the battery cell arrangement direction A1 to the other side in the supply channel 421 as indicated by an arrow F2 in FIG. 2. Then, the liquid-phase working fluid is distributed from the supply channel 421 to each of a plurality of the evaporation channels 401. At this time, since the liquid supply unit 42 does not easily receive heat of the battery pack 5, the working fluid flows into each of the evaporation channels 401 in a liquid phase. That is, the liquid-phase working fluid supplied from the condenser 14 is supplied in the liquid phase via the supply channel 421 to the vicinity of the lower side of each battery cell 51 without boiling and without a bubble flow.

In each of the evaporation channels 401, the liquid-phase working fluid flows from below to above and is vaporized by the heat of the battery pack 5. That is, the working fluid evaporates by taking heat from each battery cell 51 while flowing in the evaporation channel 401. Therefore, the working fluid in each evaporation channel 401 flows into the outflow channel 441 in a gas phase only or as a gas-liquid two-phase.

The working fluid flowing into the outflow channel 441 is gas-liquid separated and flows from one side to the other side in the battery cell arrangement direction A1 in the outflow channel 441 as indicated by an arrow F3 in FIG. 2. The gas-phase working fluid flowing to the other end in the battery cell arrangement direction A1 in the outflow channel 441 flows out of the fluid outlet 442 to the first gas passage 16 as indicated by an arrow F4 in FIG. 2.

As illustrated in FIG. 2, the partitions 46a and 46c are provided in one end region of the evaporator 12 in the battery cell arrangement direction A1. In the central region of the evaporator 12 in the battery cell arrangement direction A1, partitions 46c to 46j are provided. Partitions 46k and 46l are provided in the other end region of the evaporator 12 in the battery cell arrangement direction A1. In addition, the partitions 46a to 46l extend continuously in the direction orthogonal to the battery cell arrangement direction A1 in which a pair of metal plates face each other, but may extend intermittently with a gap in the middle. The partitions 46a to 46l not only separate the adjacent evaporation channels 401, but also contribute to the heat exchange of the liquid-phase working fluid flowing through the evaporation channels 401.

The thicknesses of the partitions 46a and 46b in one end region of the evaporator 12 in the battery cell arrangement direction A1 and the partitions 46k and 46l in the other end region of the evaporator 12 in the battery cell arrangement direction A1 are larger than the thicknesses of the partitions 46c to 46j in the central region of the evaporator 12 in the battery cell arrangement direction A1. Note that the thicknesses of the partitions 46a, 46b, 46k, and 46l are the same, and the thickness of the partition 46a is representatively indicated as t1 in FIG. 2. Further, the thicknesses of the partitions 46c to 46j are the same, and the thickness of the partition 46c is representatively indicated as t2 in FIG. 2.

Here, in the evaporator 12 according to the first embodiment, the structures of the one end region of the evaporator 12 in the battery cell arrangement direction A1 and the other end region of the evaporator 12 in the battery cell arrangement direction A1 are substantially the same. Therefore, focusing on one end region in the battery cell arrangement direction A1 of the evaporator 12, hereinafter, it is simply referred to as an end region of the evaporator 12. Further, the central region of the evaporator 12 in the battery cell arrangement direction A1 is hereinafter simply referred to as the central region of the evaporator 12.

In the evaporator 12 according to the first embodiment, as illustrated in FIG. 2, in the end region of the evaporator 12, the interval between the partition 46a and the partition 46b in the battery cell arrangement direction A1 is defined as a partition pitch x1, and the width of the evaporation channel 401 formed between the partition 46a and the partition 46b in the battery cell arrangement direction A1 is defined as an evaporation channel width y1. Further, in the evaporator 12 according to the first embodiment, as illustrated in FIG. 2, in the central region of the evaporator 12, the interval between the partition 46c and the partition 46d in the battery cell arrangement direction A1 is defined as a partition pitch x2, and the width in the battery cell arrangement direction A1 of the evaporation channel 401 formed between the partition 46c and the partition 46d is defined as an evaporation channel width y2. In the evaporator 12 according to the first embodiment, t1>t2 and y1=y2, and the relationship of (y1/x1)<(y2/x2) is satisfied.

As a result, in the end region of the evaporator 12, the width of the evaporation channel 401 per unit length in the battery cell arrangement direction A1 is smaller than the central region of the evaporator 12. That is, when the unit length is the width of the battery cell 51 in the battery cell arrangement direction A1, the width of the evaporation channel 401 for one battery cell 51 is smaller at the end region of the evaporator 12 than at the central region of the evaporator 12. In other words, heat exchange area for performing heat exchange between one battery cell 51 and a liquid-phase working fluid is smaller in the end region of the evaporator 12 than in the central region of the evaporator 12. Further, in other words, the sectional area of the evaporation channel 401 in a direction orthogonal to the vehicle vertical direction A2, that is, the evaporation channel 401 when the evaporation channel 401 is viewed from the vehicle vertical direction A2 is smaller in the end region of the evaporator 12 than in the central region of the evaporator 12.

Therefore, in the cooling device 1 according to the first embodiment, the cooling capacity (cooling amount) in the end region of the evaporator 12 becomes lower than the cooling capacity (cooling amount) in the central region of the evaporator 12, and the battery cell 51 located at the end of the battery pack 5 in the battery cell arrangement direction A1 may be suppressed from being excessively cooled as compared with the battery cell 51 located at the center in the battery cell arrangement direction A1. Therefore, in the cooling device 1 according to the first embodiment, the temperature difference between the end and the center in the battery cell arrangement direction A1 of the battery pack 5 may be reduced.

Further, in the cooling device 1 according to the first embodiment, in the battery cell arrangement direction A1, the thicknesses t1 of the partitions 46a, 46b, 46k, and 46l in the end region of the evaporator 12 are larger than the thicknesses t2 of the partitions 46c to 46j in the central region of the evaporator 12. Therefore, the joining strength when the partitions 46a to 46l are joined by brazing or the like is higher in the end region of the evaporator 12 than in the central region of the evaporator 12. Therefore, as compared with the case where the thickness of the partitions 46a, 46b, 46k, and 46l in the end region of the evaporator 12 is the same as the thickness of the partitions 46c to 46j in the central region of the evaporator 12, the joining strength of the end region of the evaporator 12 is increased, and the durability against the increase of the internal pressure in the evaporator 12 may be improved.

### Second Embodiment

Hereinafter, a second embodiment of the cooling device will be described. The description of the parts common to the first embodiment will be omitted as appropriate.

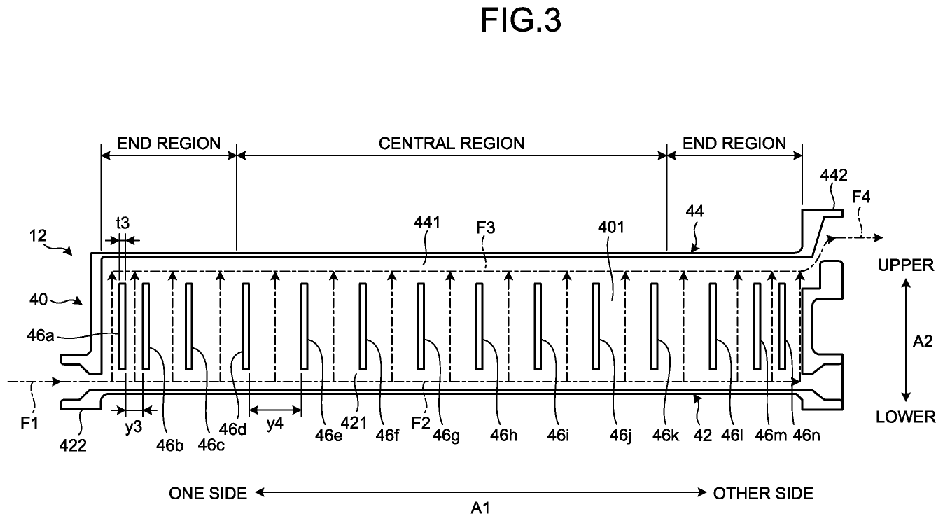

FIG. 3 is a cross-sectional view of an evaporator 12 included in a cooling device 1 according to the second embodiment. As illustrated in FIG. 3, partitions 46a to 46c are provided in one end region of the evaporator 12 in a battery cell arrangement direction A1. In the central region of the evaporator 12 in the battery cell arrangement direction A1, partitions 46d to 46k are provided. In the other side end area of the evaporator 12 in the battery cell arrangement direction A1, partitions 46l to 46n are provided. In the evaporator 12 according to the second embodiment, the thicknesses of the partitions 46a to 46n in the battery cell arrangement direction A1 are the same, and the thickness of the partition 46a is representatively indicated as t3 in FIG. 3.

Here, in the evaporator 12 according to the second embodiment, the structures of the one end region of the evaporator 12 in the battery cell arrangement direction A1 and the other end region of the evaporator 12 in the battery cell arrangement direction A1 are substantially the same. Therefore, focusing on one end region in the battery cell arrangement direction A1 of the evaporator 12, hereinafter, it is simply referred to as an end region of the evaporator 12. Further, the central region of the evaporator 12 in the battery cell arrangement direction A1 is hereinafter simply referred to as the central region of the evaporator 12.

In the evaporator 12 according to the second embodiment, as illustrated in FIG. 3, in the end region of the evaporator 12, the width of the evaporation channel 401 formed between the partition 46a and the partition 46b in the battery cell arrangement direction A1 is defined as an evaporation channel width y3. Further, in the evaporator 12 according to the second embodiment, as illustrated in FIG. 3, in the central region of the evaporator 12, the battery cell arrangement direction A1 of the evaporation channel 401 formed between the partition 46c and the partition 46d is defined as the evaporation channel width y4. The evaporator 12 according to the second embodiment satisfies the relationship of y3<y4.

As a result, in the end region of the evaporator 12, the width of the evaporation channel 401 per unit length in the battery cell arrangement direction A1 is smaller than the central region of the evaporator 12. That is, when the unit length is the width of the battery cell 51 in the battery cell arrangement direction A1, the width of the evaporation channel 401 for one battery cell 51 is smaller at the end region of the evaporator 12 than at the central region of the evaporator 12. In other words, heat exchange area for performing heat exchange between one battery cell 51 and a liquid-phase working fluid is smaller in the end region of the evaporator 12 than in the central region of the evaporator 12. Further, in other words, the sectional area of the evaporation channel 401 in a direction orthogonal to the vehicle vertical direction A2, that is, the evaporation channel 401 when the evaporation channel 401 is viewed from the vehicle vertical direction A2 is smaller in the end region of the evaporator 12 than in the central region of the evaporator 12.

Therefore, in the cooling device 1 according to the second embodiment, the cooling capacity (cooling amount) in the end region of the evaporator 12 becomes lower than the cooling capacity (cooling amount) in the central region of the evaporator 12, and the battery cell 51 located at the end of the battery pack 5 in the battery cell arrangement direction A1 may be suppressed from being excessively cooled as compared with the battery cell 51 located at the center in the battery cell arrangement direction A1. Therefore, in the cooling device 1 according to the second embodiment, the temperature difference between the end and the center in the battery cell arrangement direction A1 of the battery pack 5 may be reduced.

### Third Embodiment

Hereinafter, a third embodiment of the cooling device will be described. The description of the parts common to the first embodiment will be omitted as appropriate.

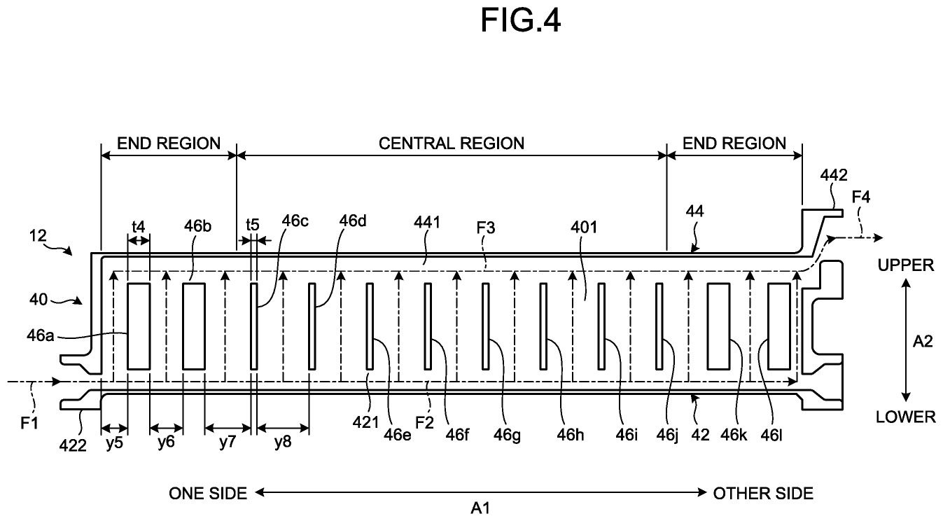

FIG. 4 is a cross-sectional view of an evaporator 12 included in a cooling device 1 according to the third embodiment. As illustrated in FIG. 4, partitions 46a and 46b are provided in one end region of the evaporator 12 in a battery cell arrangement direction A1. In the central region of the evaporator 12 in the battery cell arrangement direction A1, partitions 46c to 46j are provided. Partitions 46k and 46l are provided in the other end region of the evaporator 12 in the battery cell arrangement direction A1.

The thicknesses of the partitions 46a and 46b in one end region of the evaporator 12 in the battery cell arrangement direction A1 and the partitions 46k and 46l in the other end region of the evaporator 12 in the battery cell arrangement direction A1 are larger than the thicknesses of the partitions 46c to 46j in the central region of the evaporator 12 in the battery cell arrangement direction A1. Note that the thicknesses of the partitions 46a, 46b, 46k, and 46l are the same, and the thickness of the partition 46a is representatively indicated as t4 in FIG. 4. Further, the thicknesses of the partitions 46c to 46j are the same, and the thickness of the partition 46c is representatively indicated as t5 in FIG. 4.

Here, in the evaporator 12 according to the third embodiment, the structures of the one end region of the evaporator 12 in the battery cell arrangement direction A1 and the other end region of the evaporator 12 in the battery cell arrangement direction A1 are substantially the same. Therefore, focusing on one end region in the battery cell arrangement direction A1 of the evaporator 12, hereinafter, it is simply referred to as an end region of the evaporator 12. Further, the central region of the evaporator 12 in the battery cell arrangement direction A1 is hereinafter simply referred to as the central region of the evaporator 12.

In the evaporator 12 according to the third embodiment, as illustrated in FIG. 4, the width of the evaporation channel 401 formed between the inner end face of the fluid evaporation unit 40 and the partition 46a in the battery cell arrangement direction A1 is defined as an evaporation channel width y5, the width of the evaporation channel 401 formed between the partition 46a and the partition 46b in the battery cell arrangement direction A1 is defined as an evaporation channel width y6, the width of the evaporation channel 401 formed between the partition 46b and the partition 46c in the battery cell arrangement direction A1 is defined as an evaporation channel width y7, and the width of the evaporation channel 401 formed between the partition 46c and the partition 46d in the battery cell arrangement direction A1 is defined as an evaporation channel width y8. In the evaporator 12 according to the third embodiment, t4>t5, and the relationship of y5<y6<y7<y8 is satisfied.

As a result, in the end region of the evaporator 12, the width of the evaporation channel 401 per unit length in the battery cell arrangement direction A1 is smaller than the central region of the evaporator 12, and further becomes smaller as it is located on one side in the battery cell arrangement direction A1. That is, assuming that the unit length is the width of the battery cell 51 in the battery cell arrangement direction A1, the width of the evaporation channel 401 for one battery cell 51 is smaller than the width of the evaporator 12 with respect to the central region of the evaporator 12 and further becomes smaller as it is located on one side in the battery cell arrangement direction A1. In other words, the heat exchange area for performing heat exchange between one battery cell 51 and the liquid-phase working fluid is smaller in the end region of the evaporator 12 than in the central region of the evaporator 12 and further becomes smaller as it is located on one side in the battery cell arrangement direction A1. Further, in other words, the sectional area of the evaporation channel 401 in the direction orthogonal to the vehicle vertical direction A2, that is, the evaporation channel 401 when the evaporation channel 401 is viewed from the vehicle vertical direction A2 is smaller in the end region of the evaporator 12 than in the central region of the evaporator 12 and further becomes smaller as it is located on one side in the battery cell arrangement direction A1.

Therefore, in the cooling device 1 according to the third embodiment, the cooling capacity (cooling amount) in the end region of the evaporator 12 becomes lower than the cooling capacity (cooling amount) in the central region of the evaporator 12, and the battery cell 51 located at the end of the battery pack 5 in the battery cell arrangement direction A1 may be suppressed from being excessively cooled as compared with the battery cell 51 located at the center in the battery cell arrangement direction A1. Therefore, in the cooling device 1 according to the third embodiment, the temperature difference between the end and the center in the battery cell arrangement direction A1 of the battery pack 5 may be reduced.

Further, in the cooling device 1 according to the third embodiment, in the battery cell arrangement direction A1, the thicknesses t4 of the partitions 46a, 46b, 46k, and 46l in the end region of the evaporator 12 are larger than the thicknesses t5 of the partitions 46c to 46j in the central region of the evaporator 12. Therefore, the joining strength when the partitions 46a to 46l are joined by brazing or the like is higher in the end region of the evaporator 12 than in the central region of the evaporator 12. Therefore, as compared with the case where the thickness of the partitions 46a, 46b, 46k, and 46l in the end region of the evaporator 12 is the same as the thickness of the partitions 46c to 46j in the central region of the evaporator 12, the joining strength of the end region of the evaporator 12 is increased, and the durability against the increase of the internal pressure in the evaporator 12 may be improved.

### Fourth Embodiment

Hereinafter, a fourth embodiment of the cooling device will be described. The description of the parts common to the first embodiment will be omitted as appropriate.

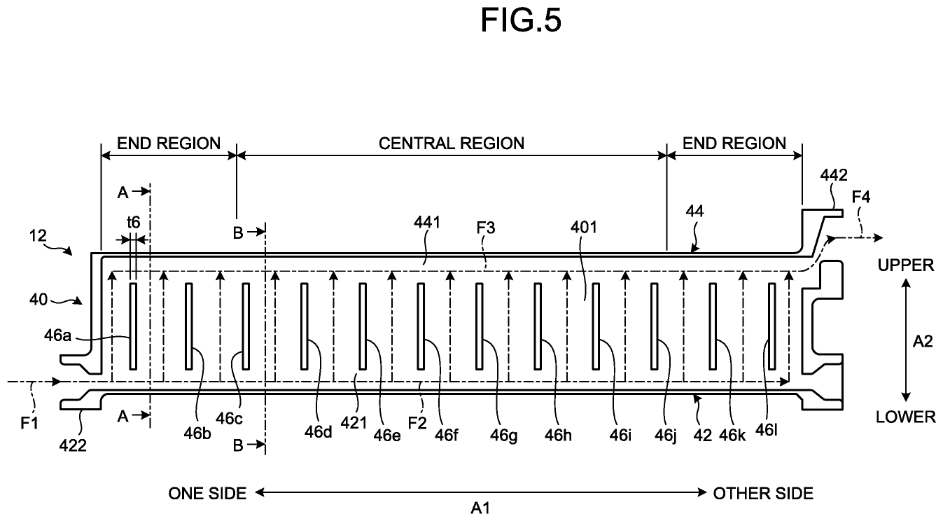

FIG. 5 is a cross-sectional view of an evaporator 12 included in the cooling device 1 according to the fourth embodiment. FIG. 5 is a cross-sectional view of an evaporator 12 included in the cooling device 1 according to the fourth embodiment. As illustrated in FIG. 5, partitions 46a and 46b are provided in one end region of the evaporator 12 in a battery cell arrangement direction A1. In the central region of the evaporator 12 in the battery cell arrangement direction A1, partitions 46c to 46j are provided. Partitions 46k and 46l are provided in the other end region of the evaporator 12 in the battery cell arrangement direction A1. In the evaporator 12 according to the fourth embodiment, the thicknesses of the partitions 46a to 46l in the battery cell arrangement direction A1 are the same, and the thickness of the partition 46a is representatively indicated as t6 in FIG. 5. Further, in the evaporator 12 according to the fourth embodiment, in the partitions 46a to 46l, the widths of the evaporation channels between the adjacent partitions are all the same.

Here, in the evaporator 12 according to the fourth embodiment, the structures of the one end region of the evaporator 12 in the battery cell arrangement direction A1 and the other end region of the evaporator 12 in the battery cell arrangement direction A1 are substantially the same. Therefore, focusing on one end region in the battery cell arrangement direction A1 of the evaporator 12, hereinafter, it is simply referred to as an end region of the evaporator 12. Further, the central region of the evaporator 12 in the battery cell arrangement direction A1 is hereinafter simply referred to as the central region of the evaporator 12.

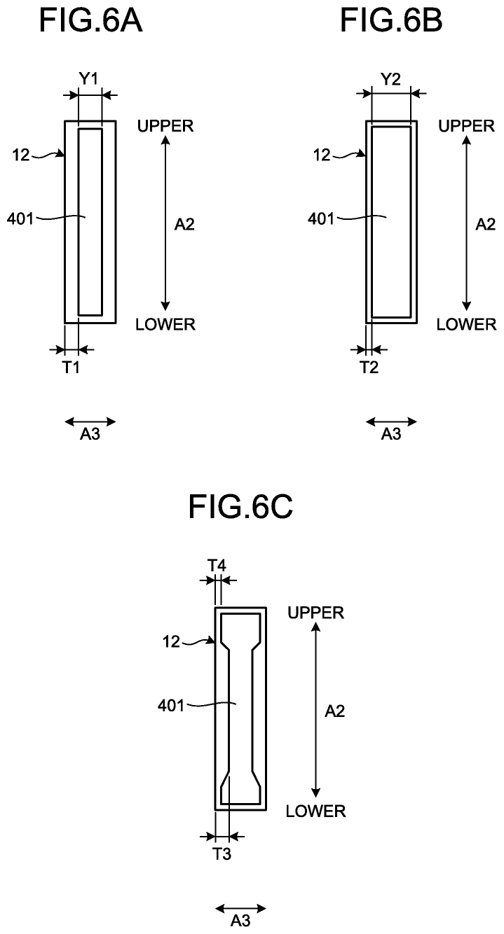

FIG. 6A is a cross-sectional view taken along line AA of FIG. 5. FIG. 6B is a cross-sectional view taken along line BB of FIG. 5. FIG. 6C is a diagram illustrating another example of a cross-section taken along line AA of FIG. 5.

In the evaporator 12 according to the fourth embodiment, as illustrated in FIG. 6A, in the end region of the evaporator 12, the thickness of the side wall of the evaporator 12 in a direction A3 orthogonal to the battery cell arrangement direction A1 is defined as T1. Further, in the evaporator 12 according to the fourth embodiment, as illustrated in FIG. 6B, in the central region of the evaporator 12, the thickness of the side wall of the evaporator 12 in the direction A3 orthogonal to the battery cell arrangement direction A1 is defined as T2. Further, in the evaporator 12 according to the fourth embodiment, the width of the evaporator 12 in the direction A3 orthogonal to the battery cell arrangement direction A1 is the same in the end region and the central region of the evaporator 12, and the relationship of T1>T2 is satisfied.

Thereby, in the end region of the evaporator 12, the width Y1 of the evaporation channel 401 in the direction A3 orthogonal to the battery cell arrangement direction A1 is smaller than the width Y2 of the evaporation channel 401 in the direction A3 orthogonal to the battery cell arrangement direction A1 in the central region of the evaporator 12. In other words, the sectional area of the evaporation channel 401 in a direction orthogonal to the vehicle vertical direction A2, that is, the evaporation channel 401 when the evaporation channel 401 is viewed from the vehicle vertical direction A2 is smaller in the end region of the evaporator 12 than in the central region of the evaporator 12. Therefore, in the evaporator 12 according to the fourth embodiment, the pressure loss in the evaporation channel 401 in the end region of the evaporator 12 is higher than the pressure loss in the evaporation channel 401 in the central region of the evaporator 12, and the flow rate of the liquid-phase working fluid flowing through the evaporation channel 401 per unit time is smaller in the end region of the evaporator 12 than in the central region of the evaporator 12.

Therefore, in the cooling device 1 according to the fourth embodiment, the cooling capacity (cooling amount) in the end region of the evaporator 12 becomes lower than the cooling capacity (cooling amount) in the central region of the evaporator 12, and the battery cell 51 located at the end of the battery pack 5 in the battery cell arrangement direction A1 may be suppressed from being excessively cooled as compared with the battery cell 51 located at the center in the battery cell arrangement direction A1. Therefore, in the cooling device 1 according to the second embodiment, the temperature difference between the end and the center in the battery cell arrangement direction A1 of the battery pack 5 may be reduced.

Note that, as illustrated in FIG. 6C, the thickness of the side wall of the evaporator 12 in the direction A3 orthogonal to the battery cell arrangement direction A1 is the thickness T3 (>T2) at the center in the vehicle vertical direction A2 and 14 (<T3) at the upper end and the lower end in the vehicle vertical direction A2, and it may be different in the vehicle vertical direction A2.

### Fifth Embodiment

Hereinafter, a fifth embodiment of the cooling device will be described. The description of the parts common to the first embodiment will be omitted as appropriate.

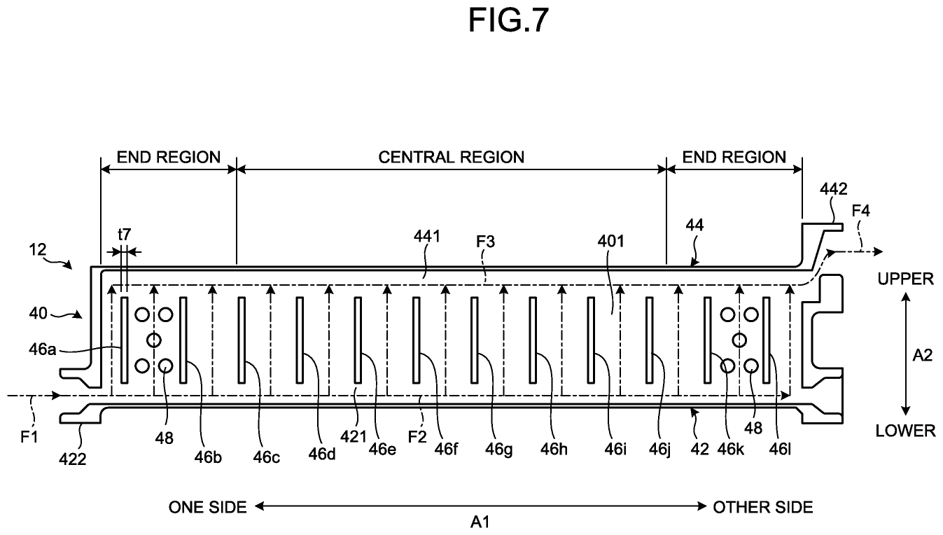

FIG. 7 is a cross-sectional view of an evaporator 12 included in a cooling device 1 according to the fifth embodiment. As illustrated in FIG. 7, partitions 46a and 46b are provided in one end region of the evaporator 12 in a battery cell arrangement direction A1. In the central region of the evaporator 12 in the battery cell arrangement direction A1, partitions 46c to 46j are provided. Partitions 46k and 46l are provided in the other end region of the evaporator 12 in the battery cell arrangement direction A1. Note that the thicknesses of the partitions 46a to 46l are the same, and the thickness of the partition 46a is representatively indicated as t7 in FIG. 7. Further, in the partitions 46a to 46l, the widths of the evaporation channels between the adjacent partitions are all the same.

Here, in the evaporator 12 according to the fifth embodiment, the structures of the one end region of the evaporator 12 in the battery cell arrangement direction A1 and the other end region of the evaporator 12 in the battery cell arrangement direction A1 are substantially the same. Therefore, focusing on one end region in the battery cell arrangement direction A1 of the evaporator 12, hereinafter, it is simply referred to as an end region of the evaporator 12. Further, the central region of the evaporator 12 in the battery cell arrangement direction A1 is hereinafter simply referred to as the central region of the evaporator 12.

As illustrated in FIG. 7, in the evaporator 12 according to the fifth embodiment, the evaporation channel 401 formed between the partition 46a and the partition 46b in the end region of the evaporator 12 is provided with a plurality of protrusions 48 protruding in a direction orthogonal to the battery cell arrangement direction A1. Note that, in the evaporator 12 according to the fifth embodiment, as illustrated in FIG. 7, the evaporation channel 401 formed between the partitions in the central region of the evaporator 12 is not provided with a protrusion such as the protrusion 48 that protrudes in the direction orthogonal to the battery cell arrangement direction A1. Further, the protrusion amount of the protrusion 48 is not particularly limited as long as the protrusion 48 obstructs the liquid-phase working fluid flowing through the evaporation channel 401, and the protrusion 48 may extend in the direction orthogonal to the battery cell arrangement direction A1 over the entire area of the evaporation channel 401 or may be smaller than the width of the evaporation channel 401.

Thereby, when the liquid-phase working fluid flows through the evaporation channel 401, a plurality of the protrusions 48 provide resistance in the end region of the evaporator 12. Therefore, in the evaporator 12 according to the fifth embodiment, the pressure loss in the evaporation channel 401 in the end region of the evaporator 12 is higher than the pressure loss in the evaporation channel 401 in the central region of the evaporator 12. In the end region of the evaporator 12, the provision of a plurality of the protrusions 48 makes the evaporation channel 401 narrower than the central region of the evaporator 12. Further, the flow velocity of the liquid-phase working fluid in the evaporation channel 401 is slower in the end region of the evaporator 12 than in the central region of the evaporator 12 due to a plurality of the protrusions 48. Therefore, in the evaporator 12 according to the fifth embodiment, the flow rate of the liquid-phase working fluid flowing through evaporation channel 401 per unit time is smaller in the end region of the evaporator 12 than in the central region of the evaporator 12.

Therefore, in the cooling device 1 according to the fifth embodiment, the cooling capacity (cooling amount) in the end region of the evaporator 12 becomes lower than the cooling capacity (cooling amount) in the central region of the evaporator 12, and the battery cell 51 located at the end of the battery pack 5 in the battery cell arrangement direction A1 may be suppressed from being excessively cooled as compared with the battery cell 51 located at the center in the battery cell arrangement direction A1. Therefore, in the cooling device 1 according to the third embodiment, the temperature difference between the end and the center in the battery cell arrangement direction A1 of the battery pack 5 may be reduced.

### Sixth Embodiment

Hereinafter, a sixth embodiment of the cooling device will be described. The description of the parts common to the first embodiment will be omitted as appropriate.

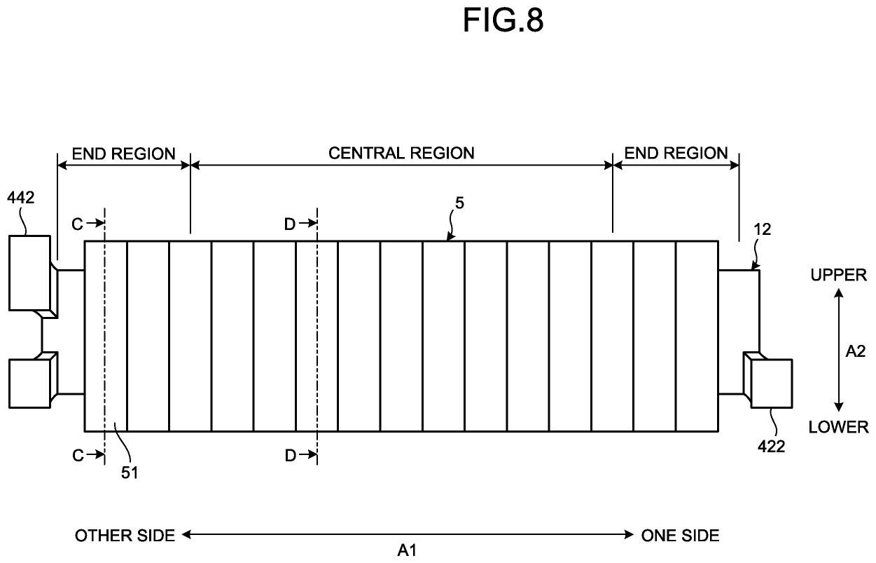

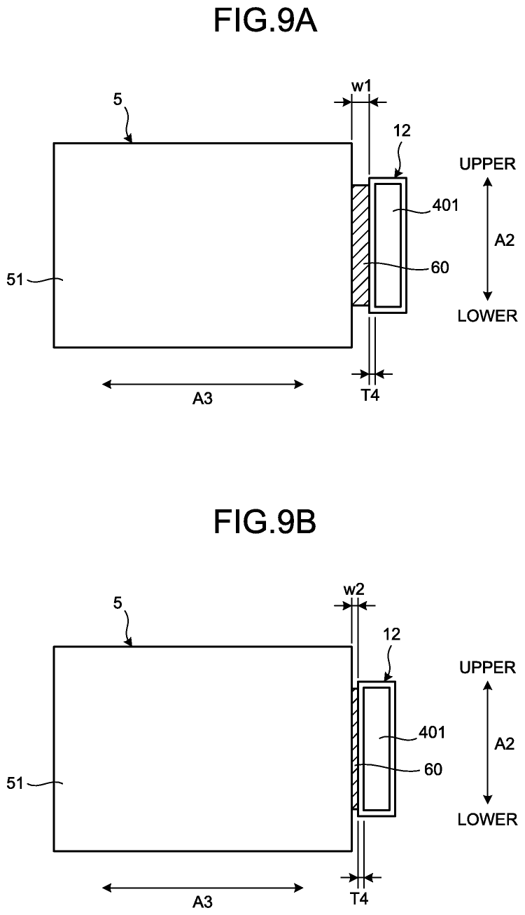

FIG. 8 is a diagram of the battery pack 5 and the evaporator 12 provided in the cooling device 1 according to the sixth embodiment as viewed from the battery pack 5 side in the direction orthogonal to the battery cell arrangement direction A1. FIG. 9A is a cross-sectional view taken along line CC of FIG. 8. FIG. 9B is a cross-sectional view taken along line DD of FIG. 8.

In the cooling device 1 according to the sixth embodiment, a heat conductive material 60 is disposed between the battery pack 5 and the evaporator 12, and heat is transferred from each battery cell 51 of the battery pack 5 to the liquid-phase working fluid in the evaporator 12 via the heat conductive material 60.

Here, in the cooling device 1 according to the sixth embodiment, the structures of the one end regions in the battery cell arrangement direction A1 of the battery pack 5, the evaporator 12, and the heat conductive material 60 and the other end region in the battery cell arrangement direction A1 of the evaporator 12 are substantially the same. Therefore, focusing on the other end region in the battery cell arrangement direction A1 of the battery pack 5, the evaporator 12, and the heat conductive material 60, hereinafter, it is simply referred to as an end region. Further, hereinafter the central regions in the battery cell arrangement direction A1 of the battery pack 5, the evaporator 12, and the heat conductive material 60 are simply referred to as a central region.

In the end region of the cooling device 1 according to the sixth embodiment, as illustrated in FIG. 9A, the thickness of the heat conductive material 60 disposed between the battery pack 5 and the evaporator 12 is defined as w1. Further, in the central region of the cooling device 1 according to the sixth embodiment, as illustrated in FIG. 9(b), the thickness of the heat conductive material 60 disposed between the battery pack 5 and the evaporator 12 is defined as w2. Note that, in the cooling device 1 according to the sixth embodiment, the thickness of the side wall of the evaporator 12 on the battery pack 5 side in the direction A3 orthogonal to the battery cell arrangement direction A1 is the same in the end region and the central region and defined as a thickness 14. The cooling device 1 according to the sixth embodiment satisfies the relationship w1>w2.

Thereby, in the cooling device 1 according to the sixth embodiment, heat transfer distance from the battery cell 51 of the battery pack 5 to the liquid-phase working fluid flowing through the evaporation channel 401 in the evaporator 12 via the heat conductive material 60 is farther in the end region than in the central region. Therefore, the amount of heat transfer from the battery cells 51 to the liquid-phase working fluid flowing through the evaporation channel 401 in the evaporator 12 is smaller in the end region than in the central region.

Therefore, in the cooling device 1 according to the sixth embodiment, the cooling capacity (cooling amount) in the end region of the evaporator 12 becomes lower than the cooling capacity (cooling amount) in the central region of the evaporator 12, and the battery cell 51 located at the end of the battery pack 5 in the battery cell arrangement direction A1 may be suppressed from being excessively cooled as compared with the battery cell 51 located at the center in the battery cell arrangement direction A1. Therefore, in the cooling device 1 according to the sixth embodiment, the temperature difference between the end and the center in the battery cell arrangement direction A1 of the battery pack 5 may be reduced.

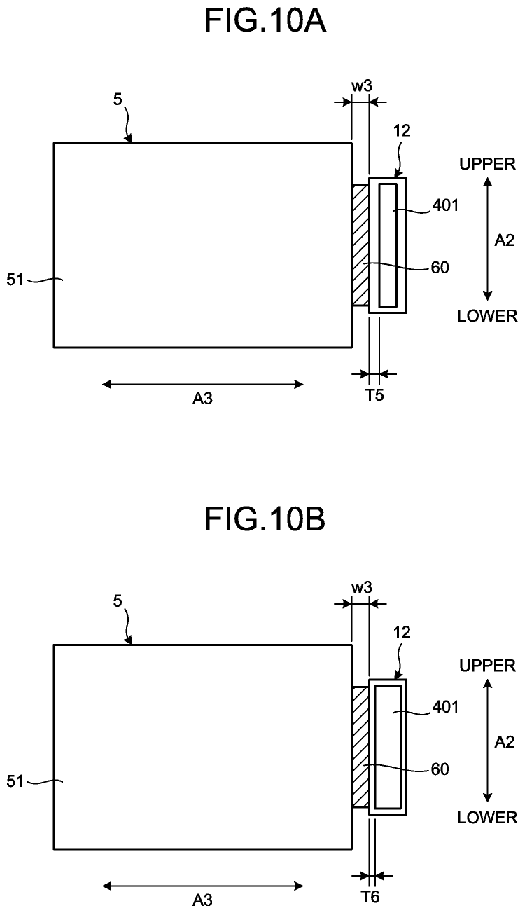

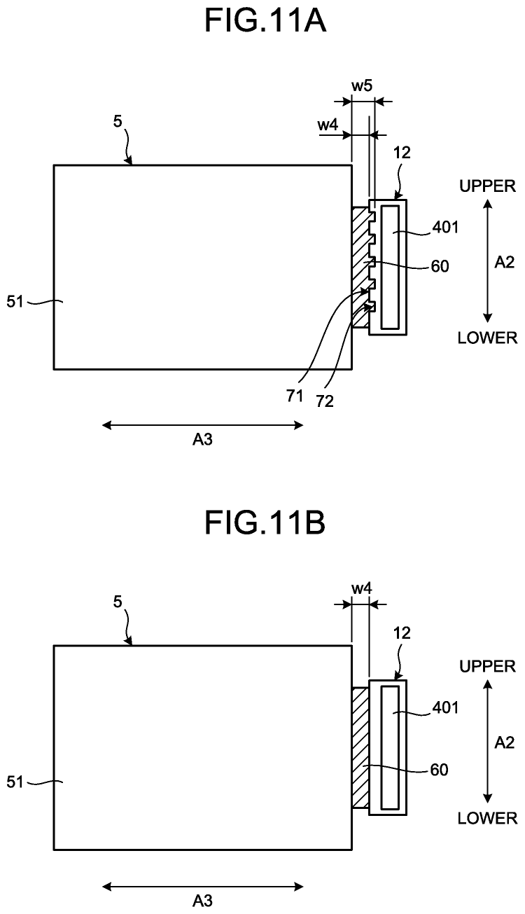

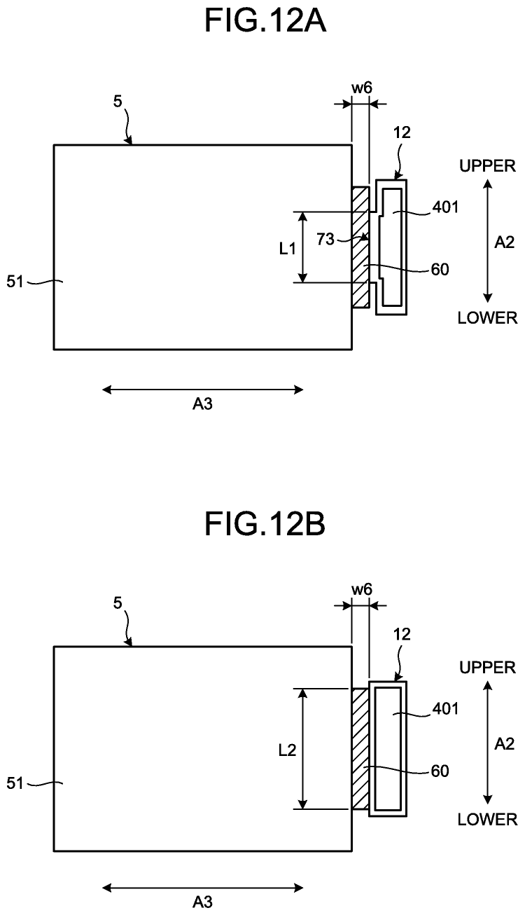

Note that that the cooling device 1 according to the sixth embodiment is not limited to the configuration in which the thickness of the heat conductive material 60 is different such that the amount of heat transferred to the liquid-phase working fluid flowing from the battery cell 51 to the evaporation channel 401 in the evaporator 12 is different between the end region and the central region. FIG. 10A is a diagram illustrating another example of a cross section taken along line CC of FIG. 8. FIG. 10B is a diagram illustrating another example of a cross section taken along line DD of FIG. 8. FIG. 11A is a diagram illustrating another example of a cross section taken along line CC of FIG. 8. FIG. 11B is a diagram illustrating another example of a cross section taken along line DD of FIG. 8. FIG. 12A is a diagram illustrating another example of a cross section taken along line CC of FIG. 8. FIG. 12B is a diagram illustrating another example of a cross section taken along line DD of FIG. 8.

For example, as illustrated in FIGS. 10A and 10B, the thickness of the heat conductive material 60 is the same in the end region and the central region and defined as a thickness w3, and the thickness of the side wall of the evaporator 12 on the battery pack 5 side in the direction A3 orthogonal to the battery cell arrangement direction A1 is defined as T5 in the end region and T6 (<T5) in the central region. In this case also, the heat transfer distance is farther in the end region than in the central region, and the amount of heat transfer from the battery cells 51 to the liquid-phase working fluid flowing through the evaporation channel 401 in the evaporator 12 is smaller in the end region than in the central region.

Further, for example, as illustrated in FIG. 11A, in the end region, the surface of the evaporator 12 on the side in contact with the heat conductive material 60 is an uneven surface having protruding portions 71 and recessed portions 72 alternately in the vehicle vertical direction A2. At this time, as illustrated in FIG. 11B, in the central region, the surface of the evaporator 12 on the side in contact with the heat conductive material 60 is a flat surface. Further, in the direction A3 orthogonal to the battery cell arrangement direction A1, the thickness w4 of the heat conductive material 60 at the portion in contact with the protruding portion 71 of the evaporator 12 at the end region is same as the thickness w4 of the heat conductive material 60 in the central region.

On the other hand, in the direction A3 orthogonal to the battery cell arrangement direction A1, the thickness w5 of the heat conductive material 60 at the portion in contact with the recessed portion 72 of the evaporator 12 at the end region is thicker than the thickness w4 of the heat conductive material 60 in the central region. Therefore, of the heat transfer distance from the battery cell 51 of the battery pack 5 to the liquid-phase working fluid flowing through the evaporation channel 401 in the evaporator 12 via the heat conductive material 60, the proportion occupied by the heat conductive material 60 is larger in the end region than in the central region. With the metal evaporator 12 and the resin heat conductive material 60, the heat conductive material 60 has a lower thermal conductivity than the evaporator 12, such that the amount of heat transfer from the battery cell 51 to the liquid-phase working fluid flowing through the evaporation channel 401 in the evaporator 12 is smaller in the end region than in the central region.

Further, for example, as illustrated in FIGS. 12A and 12B, in the direction A3 orthogonal to the battery cell arrangement direction A1, the thickness of the heat conductive material 60 is the same in the end region and the central region and defined as a thickness w6. Then, as illustrated in FIG. 12A, in the end region, the width in the vehicle vertical direction A2 of a protruding portion 73 forming a surface in contact with the heat conductive material 60 of the evaporator 12 is defined as L1, and as illustrated in FIG. 12B, in the central region, the width of the surface of the evaporator 12 in contact with the heat conductive material 60 in the vehicle vertical direction A2 is defined as L2 (>L1).

Thereby, the contact area between the evaporator 12 and the heat conductive material 60 is smaller in the end region than in the central region. Therefore, the amount of heat transfer from the battery cells 51 to the liquid-phase working fluid flowing through the evaporation channel 401 in the evaporator 12 is smaller in the end region than in the central region.

### Seventh Embodiment

Hereinafter, a seventh embodiment of the cooling device will be described. The description of the parts common to the first embodiment will be omitted as appropriate.

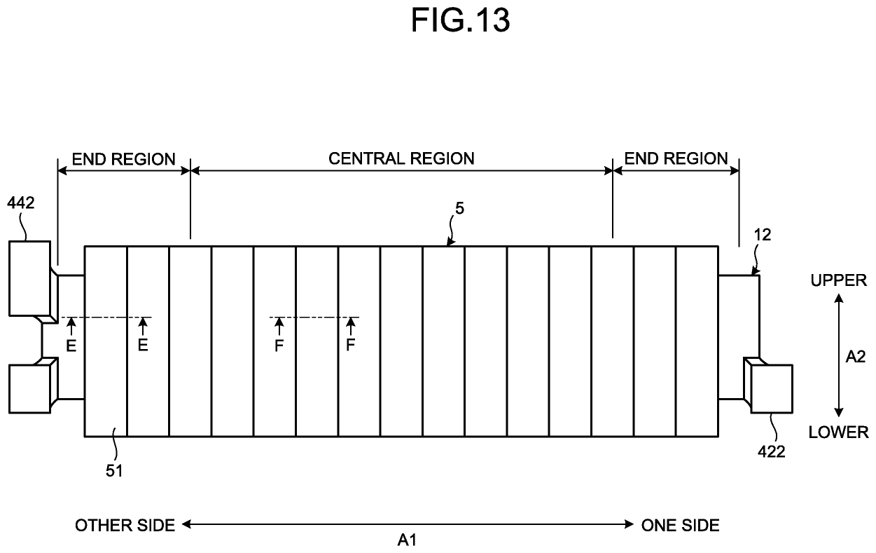

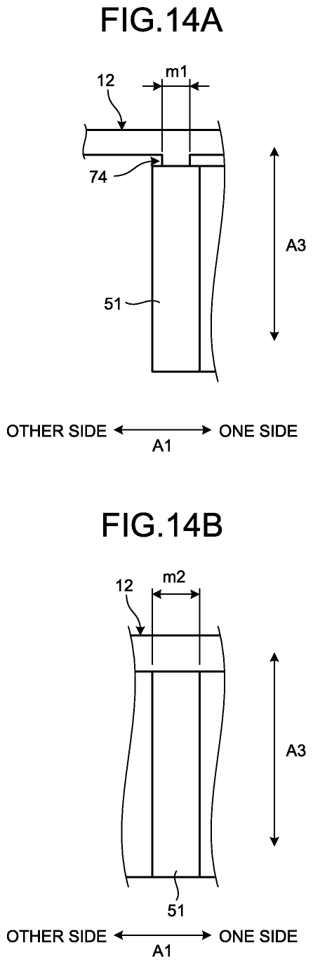

FIG. 13 is a diagram of a battery pack 5 and an evaporator 12 provided in the cooling device 1 according to the seventh embodiment as viewed from the battery pack 5 side in the direction orthogonal to a battery cell arrangement direction A1. FIG. 14A is a cross-sectional view taken along line EE of FIG. 13. FIG. 14B is a cross-sectional view taken along line FF of FIG. 13.

Here, in the cooling device 1 according to the seventh embodiment, the structures of the one end region in the battery cell arrangement direction A1 of the battery pack 5 and the evaporator 12 and the other end region in the battery cell arrangement direction A1 of the evaporator 12 are substantially the same. Therefore, focusing on the other end region in the battery cell arrangement direction A1 of the battery pack 5 and the evaporator 12, hereinafter, it is simply referred to as an end region. Further, hereinafter the central regions in the battery cell arrangement direction A1 of the battery pack 5, the evaporator 12, and the heat conductive material 60 are simply referred to as a central region.

In the cooling device 1 according to the seventh embodiment, no heat conductive material is provided between the evaporator 12 and the battery pack 5, and the evaporator 12 and the battery cell 51 of the battery pack 5 are in direct contact. Then, the width m1 in the battery cell arrangement direction A1 of a protruding portion 74 forming a surface in contact with the heat conductive material 60 of the evaporator 12 in the end region as illustrated in FIG. 14A is smaller than the width m2 of the surface of the evaporator 12 in contact with the heat conductive material 60 in the battery cell arrangement direction A1 in the central region as illustrated in FIG. 14B. Note that the protruding portion 74 extends in the vehicle vertical direction A2, and may be continuous with the protruding portion 74 of the evaporator 12 in an R shape with a side surface adjacent in the battery cell arrangement direction A1.

Thereby, in the cooling device 1 according to the seventh embodiment, the contact area between the evaporator 12 and the battery cell 51 is smaller in the end region than in the central region. Therefore, the amount of heat transfer from the battery cells 51 to the liquid-phase working fluid flowing through the evaporation channel 401 in the evaporator 12 is smaller in the end region than in the central region.

Therefore, in the cooling device 1 according to the seventh embodiment, the cooling capacity (cooling amount) in the end region of the evaporator 12 becomes lower than the cooling capacity (cooling amount) in the central region of the evaporator 12, and the battery cell 51 located at the end of the battery pack 5 in the battery cell arrangement direction A1 may be suppressed from being excessively cooled as compared with the battery cell 51 located at the center in the battery cell arrangement direction A1. Therefore, in the cooling device 1 according to the seventh embodiment, the temperature difference between the end and the center in the battery cell arrangement direction A1 of the battery pack 5 may be reduced.

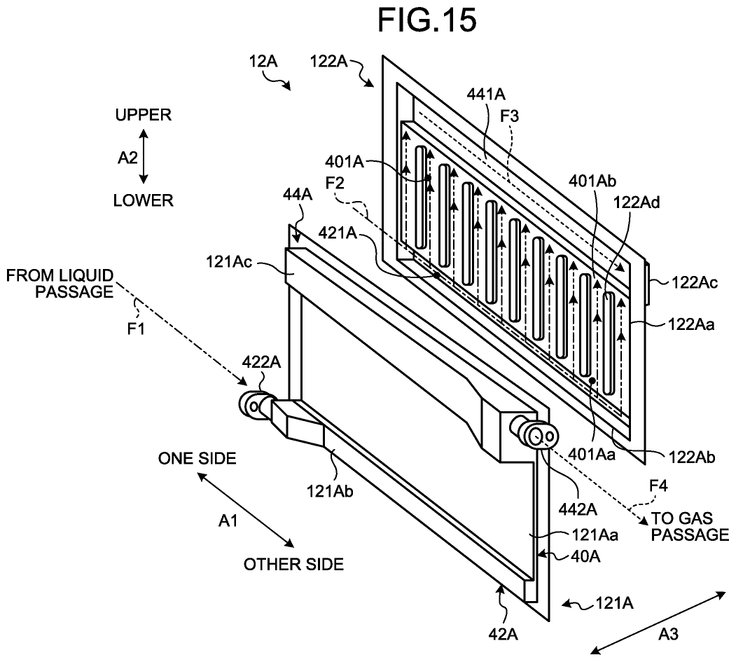

Note that, in each of the above embodiments, the evaporator 12 is not limited to one in which a pair of metal pieces is subjected to cutting and joined to be integrally formed, and the evaporator 12 may be one formed by pressing a pair of metal plates and joining them together, such as the evaporator 12A illustrated in FIG. 15.

The evaporator 12A illustrated in FIG. 15 has a plate laminated structure, and has a first plate member 121A and a second plate member 122A. Further, the evaporator 12A is configured such that a pair of the first plate member 121A and the second plate member 122A are laminated, and are joined to each other at a peripheral portion of the first plate member 121A and the second plate member 122A. Each of the first plate member 121A and the second plate member 122A is made of a metal such as an aluminum alloy having high thermal conductivity, and is a molded product formed by press working. Further, the joining between the first plate member 121A and the second plate member 122A is performed by, for example, brazing or laser welding.

Specifically, the first plate member 121A includes a first evaporation forming unit 121Aa included in a fluid evaporation unit 40A, a first supply forming unit 121Ab included in a liquid supply unit 42A, and a first outflow forming unit 121Ac included in a fluid outflow unit 44A. Further, the second plate member 122A includes a second evaporation forming unit 122Aa included in the fluid evaporation unit 40A, a second supply forming section 122Ab included in the liquid supply unit 42A, and a second outflow forming unit 122Ac included in the fluid outflow unit 44A.

Further, an evaporation channel 401A, a supply channel 421A, and an outflow channel 441A are formed as an internal space of the evaporator 12A by mutual joining of the first plate member 121A and the second plate member 122A. That is, by joining the first plate member 121A and the second plate member 122A, a plurality of the evaporation channels 401A are formed between the first evaporation forming unit 121Aa and the second evaporation forming unit 122Aa. Further, by joining the first plate member 121A and the second plate member 122A, the supply channel 421A is formed between the first supply forming unit 121Ab and the second supply forming unit 122Ab. Further, by joining the first plate member 121A and the second plate member 122A, the outflow channel 441A is formed between the first outflow forming unit 121Ac and the second outflow forming unit 122Ac.

The first evaporation forming unit 121Aa is disposed between the second evaporation forming unit 122Aa and the battery pack 5. Therefore, the fluid evaporation unit 40A is in contact with the heat conductive material at the first evaporation forming unit 121Aa.

The second evaporation forming unit 122Aa of the second plate member 122A has a plurality of protruding portions 122Ad protruding toward the first evaporation forming unit 121Aa of the first plate member 121A. Each of a plurality of the protruding portions 122Ad is formed to extend in the vehicle vertical direction A2. In other words, each of the protruding portions 122Ad is formed to extend from the liquid supply unit 42A side to the fluid outflow unit 44A side of the fluid evaporation unit 40A.

Each of the protruding portions 122Ad is in contact with the first evaporation forming unit 121Aa and is joined to the first evaporation forming unit 121Aa. The joining is performed by, for example, brazing or laser welding. A plurality of the protruding portions 122Ad abut and is joined to the first evaporation forming unit 121Aa to partition a plurality of the evaporation channels 401A from each other.

Note that each of the first evaporation forming unit 121Aa and the second evaporation forming unit 122Aa may be provided with a plurality of protrusions protruding toward a center line passing through the center of the evaporator 12 in the direction A3 orthogonal to the battery cell arrangement direction A1. For example, in the first evaporation forming unit 121Aa and the second evaporation forming unit 122Aa, a plurality of protrusions each protruding toward the center line side may be formed so as to extend in the vehicle vertical direction A2, and the protrusions may be joined to partition a plurality of the evaporation channels 401A from each other. In addition, all of the protrusions need not necessarily be joined to each other, and a gap may be provided between some of the protrusions. For example, protrusions joined each other and protrusions having a gap therebetween may be provided alternately in the battery cell arrangement direction A1.

Since a plurality of the protruding portions 122Ad are disposed side by side at intervals in the battery cell arrangement direction A1, a plurality of the evaporation channels 401A are disposed side by side in the battery cell arrangement direction A1. Specifically, the protruding portions 122Ad and the evaporation channels 401A are alternately arranged in the battery cell arrangement direction A1. For example, the evaporation channels 401A are provided in the same number as the battery cells 51, and are disposed such that one evaporation channel 401A is allocated to each battery cell 51.

Further, each of the cross sections of a plurality of the evaporation channels 401A has a flat cross section extending in the battery cell arrangement direction A1. In other words, in a cross section orthogonal to the extending direction of the evaporation channel 401A (that is, in the present embodiment, the vehicle vertical direction A2), the cross-sectional shape of the evaporation channel 401A is a flat shape with the battery cell arrangement direction A1 as a longitudinal direction.

Further, each of the evaporation channels 401A has a lower end of the evaporation channel 401A as an upstream end 401Aa on the upstream side in the working fluid flow direction, and has an upper end of the evaporation channel 401A as a downstream end 401Ab that is downstream in the working fluid flow direction. In the evaporation channel 401A, the working fluid flows from the upstream end 401Aa to the downstream end 401Ab as indicated by a dashed-dotted arrow and a broken arrow in FIG. 15. That is, in the evaporation channel 401A, the working fluid flows from below to above.

The upstream ends 401Aa of a plurality of the evaporation channels 401A are each connected to the supply channel 421A. Therefore, the liquid supply unit 42A distributes and supplies the liquid-phase working fluid that has flowed into the supply channel 421A from the liquid passage 18 via a fluid inlet 422A to each of the evaporation channels 401A.

On the other hand, the downstream ends 401Ab of a plurality of the evaporation channels 401A are connected to the outflow channel 441A. Therefore, the working fluid flows into the outflow channel 441A from each of the evaporation channels 401A. Then, the fluid outflow unit 44A causes the working fluid flowing into the outflow channel 441A to flow out to the first gas passage 16 and the second gas passage 17 via a fluid outlet 442A.

Further, in the evaporator 12A illustrated in FIG. 15, various configurations as described in the above embodiments are applied. The cooling capacity (cooling amount) of the end region of the evaporator 12A in the battery cell arrangement direction A1 (the longitudinal direction of the evaporator 12A) is lower than the cooling capacity (cooling amount) of the central region of the evaporator 12A in the battery cell arrangement direction A1, such that excessive cooling of the end of the battery pack 5 may be suppressed. Therefore, also in the evaporator 12A illustrated in FIG. 15, the temperature difference between the end and the center in the battery cell arrangement direction A1 of the battery pack 5 may be reduced.

According to the present disclosure, in an evaporation channel located at the end of an evaporator in a battery cell arrangement direction, since the heat exchange area for performing heat exchange between a battery cell and a liquid phase heat medium per unit length is smaller than the center in the battery cell arrangement direction of the evaporator, the cooling capacity may be reduced.

According to the present disclosure, in the ends in the battery cell arrangement direction of the evaporator, since the heat exchange area for performing heat exchange between a single battery cell and a liquid phase heat medium is smaller than the center in the battery cell arrangement direction of the evaporator, the cooling capacity may be reduced.

According to the present disclosure, in the evaporation channel located at the ends in the battery cell arrangement direction of the evaporator, the pressure loss becomes higher than the evaporation channel located at the center in the battery cell arrangement direction of the evaporator, and the flow rate of the liquid phase heat medium per unit time is reduced, and the cooling capacity may be reduced.

According to the present disclosure, the amount of heat transferred from the battery cells to the heat medium at the ends in the battery cell arrangement direction is smaller than that at the center in the battery cell arrangement direction, and the cooling capacity may be reduced.

According to the present disclosure, the amount of heat transferred from the battery cells to the heat medium at the end in the battery cell arrangement direction of the evaporator is smaller than that at the center in the battery cell arrangement direction of the evaporator, and the cooling capacity may be reduced.

According to the present disclosure, it is possible to prevent that the cooling capacity at the ends in the battery cell arrangement direction of the evaporator is lower than the cooling capacity at the center in the battery cell arrangement direction of the evaporator, and the battery cells located at the ends in the battery cell arrangement direction of the battery pack is excessively cooled than the battery cells located at the center in the battery cell arrangement direction. Therefore, the cooling device according to the present disclosure has an effect that the temperature difference between the ends and the center in the battery cell arrangement direction of the battery pack may be reduced.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A cooling device comprising:
an evaporator configured to cool a battery pack by evaporating a heat medium by heat exchange between the battery pack and the heat medium, the battery pack including a plurality of battery cells arranged in an arrangement direction;
a condenser disposed above the evaporator and configured to radiate heat of the heat medium to an external fluid by condensing the heat medium by heat exchange between the heat medium and the external fluid;
a gas-phase passage configured to guide the heat medium in a gas phase from the evaporator to the condenser; and
a liquid-phase passage configured to guide the heat medium in a liquid phase from the condenser to the evaporator,
wherein a cooling amount at an end of the evaporator in the arrangement direction is lower than a cooling amount at a center of the evaporator in the arrangement direction.

2. The cooling device according to claim 1, wherein the evaporator includes therein a plurality of evaporation channels extending in a vertical direction, the plurality of evaporation channels being formed in parallel in the arrangement direction, and
a width of the evaporation channels per unit length in the arrangement direction is narrower at the end in the arrangement direction than at the center in the arrangement direction.

3. The cooling device according to claim 2, wherein the unit length is a width of the battery cell in the arrangement direction.

4. The cooling device according to claim 2, wherein the evaporator includes therein a plurality of partitions configured to separate the evaporation channels adjacent in the arrangement direction, and
an interval between adjacent partitions in the arrangement direction is narrower at the end of the evaporator in the arrangement direction than at the center in the arrangement direction.

5. The cooling device according to claim 3, wherein the evaporator includes therein a plurality of partitions configured to separate the evaporation channels adjacent in the arrangement direction, and
an interval between adjacent partitions in the arrangement direction is narrower at the end of the evaporator in the arrangement direction than at the center in the arrangement direction.

6. The cooling device according to claim 1, wherein the evaporator includes therein a plurality of evaporation channels extending in a vertical direction, the plurality of evaporation channels being formed in parallel in the arrangement direction, and
in a direction orthogonal to the arrangement direction, a distance between the heat medium flowing through the evaporation channel and the battery cell is farther at the end in the arrangement direction of the evaporator than at the center in the arrangement direction of the evaporator.

7. The cooling device according to claim 1, wherein the evaporator includes therein a plurality of evaporation channels extending in a vertical direction, the plurality of evaporation channels being formed in parallel in the arrangement direction, and
a contact surface between the end of the evaporator in the arrangement direction and the battery cell is smaller than a contact surface between the center of the evaporator in the arrangement direction and the battery cell.
